(19) United States
(12) Patent Application Publication
(10) Pub. No.: US 2011/0149910 A1
(43) Pub. Date: Jun. 23, 2011

(54) METHOD FOR COMMUNICATION CHANNEL CONTROL

(75) Inventors: Dong Hyun AHN, Daejeon (KR); Choongil YEH, Daejeon (KR); Dong Seung KWON, Daejeon (KR)

(73) Assignee: Electronics and Telecommunications Research Institute, Daejeon (KR)

(21) Appl. No.: 12/972,875

(22) Filed: Dec. 20, 2010

(30) Foreign Application Priority Data
Dec. 21, 2009 (KR) 10-2009-0128404

(51) Int. Cl. H04W 36/00; H04W 28/00

(52) U.S. Cl. 370/331; 370/328; 370/329

(57) ABSTRACT

A base station designates an identification symbol section in each communication frame in order to identify a plurality of transceivers, transmits a predetermined transceiver identification signal through subcarriers granted to the plurality of transceivers by granting a combination of subcarriers to be used in an identification symbol section to each of the plurality of transceivers, generates and stores terminal connection information for each of the plurality of transceivers by receiving information on evaluation of reception quality for the transceiver from the terminal and using the received information, and allocates a communication resource so as to use the subcarrier of the transceiver connected with the terminal for communicating with the terminal.

### CROSS-REFERENCE TO RELATED APPLICATION

This application claims priority to and the benefit of Korean Patent Application No. 10-2009-0128404 filed in the Korean Intellectual Property Office on Dec. 21, 2009, the entire contents of which are incorporated herein by reference.

### BACKGROUND OF THE INVENTION

(a) Field of the Invention

The present invention relates to a method for communication channel control. More particularly, the present invention relates to a method for communication channel control to provide a location-based communication service.

(b) Description of the Related Art

The known location-based communication service is provided based on an estimated distance between a base station and a terminal by mounting an additional location-based module in the terminal or using received signal strength.

According to the known service, however, the location recognition module should be mounted on the terminal in order to provide the location-based service. Further, it is difficult to estimate an accurate location of the terminal from the estimated distance between the base station and the terminal.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for communication channel control having advantages of providing a location-based communication service to a terminal or a mobile station without a location recognition module.

An exemplary embodiment of the present invention provides a method for communication channel control for a base station including a plurality of transceivers to provide a location-based service to a terminal, that includes: designating an identification symbol section in a communication frame in order to identify the plurality of transceivers and transmitting a predetermined transceiver identification signal through subcarriers granted to the plurality of transceivers by granting a combination of subcarriers to be used in the identification symbol section to each of the plurality of transceivers; generating and storing terminal connection information for each of the plurality of transceivers by receiving information on evaluation of reception quality for the transceiver from the terminal and using the received information; and allocating a communication resource so as to use the subcarrier of the transceiver connected with the terminal for communicating with the terminal.

Another embodiment of the present invention provides a method for communication channel control for a terminal to receive a communication access service based on the location of the terminal from a base station including a plurality of transceivers, that includes: receiving a transceiver identification symbol signal included in a downlink frame section of a communication frame from the base station; evaluating the quality of a received signal of each of the plurality of transceivers by using a combination of subcarriers for each of the plurality of transceivers; and transmitting transceiver identification result information including an evaluation result of the quality of the received signal.

Yet another embodiment of the present invention provides a method for communication channel control for a communication system including a plurality of base stations to provide a mobile access service using single frequency band, the method includes: allocating channels to the plurality of transceivers so that a plurality of transceivers included in a first base station among the plurality of base stations use different channels from adjacent transceivers taking charge of adjacent communication areas; allowing the plurality of transceivers to transmit identification signals to the terminal by using subcarriers of the allocated channels by disposing a transceiver identification symbol section in a downlink frame depending on the channels allocated to the plurality of transceivers; generating and storing terminal connection information for the plurality of transceivers on the basis of the transceiver identification result information received from the terminal; and allocating a channel resource so as to transmit and receive signals through the transceiver connected to the terminal depending on the terminal connection information.

### BRIEF DESCRIPTION OF THE DRAWINGS

FIG. 1 is a service conceptual diagram of a base station system according to an embodiment of the present invention;

FIG. 2 is a diagram illustrating a configuration of a base station system according to another embodiment of the present invention;

FIG. 3 is a diagram illustrating a structure of an OFDMA frame according to an embodiment of the present invention;

FIG. 4 is a diagram illustrating a method for generating connection information according to an embodiment of the present invention;

FIG. 5 is a diagram illustrating one example of a configuration of a transceiver identification symbol according to an embodiment of the present invention;

FIG. 6 is a diagram illustrating a method for updating connection information according to an embodiment of the present invention;

FIG. 7 is a diagram illustrating a configuration of an electronic toll collection system according to another embodiment of the present invention; and

FIG. 8 is a diagram illustrating a configuration of a single frequency network at the roadside according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising” will be understood to imply the inclusion of stated elements but not the exclusion of any other elements.

In the specification, a mobile station (MS) may designate a terminal, a mobile terminal (MT), a subscriber station (SS), a portable subscriber station (PSS), user equipment (UE), an access terminal (AT), etc., and may include the entire or partial functions of the mobile terminal, the subscriber station, the portable subscriber station, the user equipment, etc.

In the specification, a base station (BS) may designate an access point (AP), a radio access station (RAS), a node B, a base transceiver station (BTS), a mobile multihop relay (MMR)-BS, etc., and may include the entire or partial functions of the access point, the radio access station, the node B, the base transceiver station, the MMR-BS, etc.

Hereinafter, a method for communication channel control for providing a location-based communication service according to an embodiment of the present invention will be described in detail with reference to the accompanying drawings.

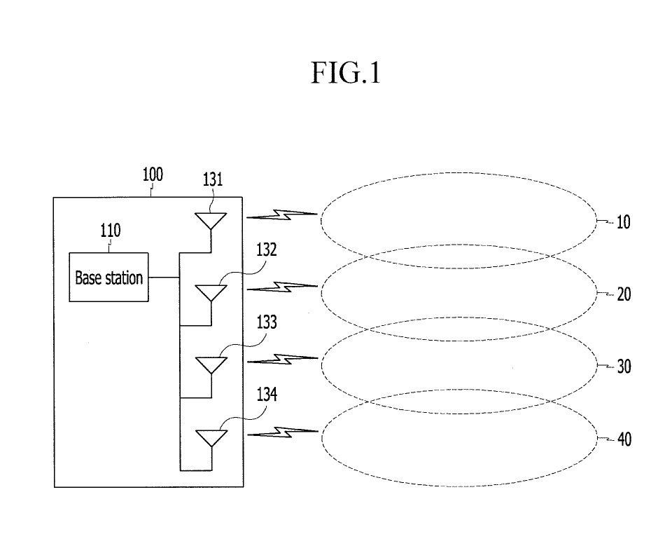

First, a service concept of a base station system according to an embodiment of the present invention will be described with reference to FIG. 1.

FIG. 1 is a service conceptual diagram of a base station system according to an embodiment of the present invention.

As shown in FIG. 1, a base station system 100 includes a base station 110 and a plurality of transceivers, i.e., a first transceiver 131, a second transceiver 132, a third transceiver 133, and a fourth transceiver 134.

The base station 110 divides a communication area of the base station system 100 into a plurality of subareas, i.e., a first subarea 10, a second subarea 20, a third subarea 30, and a fourth subarea 40 in accordance with a service characteristic and disposes the plurality of transceivers in the plurality of subareas, respectively, for communication that is suitable for service characteristics of the subareas.

The first transceiver 131 communicates with a mobile station located at the first subarea 10. The second transceiver 132 communicates with a mobile station located at the second subarea 20. The third transceiver 133 communicates with a mobile station located at the third subarea 30. The fourth transceiver 134 communicates with a mobile station located at the fourth subarea 40.

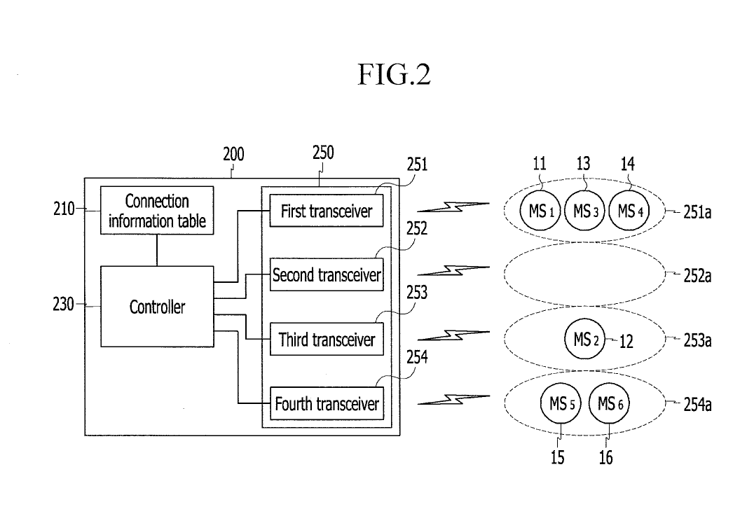

Next, referring to FIG. 2, a configuration of a base station system according to another embodiment of the present invention will be described.

FIG. 2 is a diagram illustrating a configuration of a base station system according to another embodiment of the present invention.

As shown in FIG. 2, a base station system 200 includes a connection information table 210, a controller 230, and a plurality of transceivers 250. In FIG. 2, the base station system 200 includes four transceivers, i.e., a first transceiver 251, a second transceiver 252, a third transceiver 253, and a fourth transceiver 254, but may not be limited thereto.

The connection information table 210 stores connection information between a transceiver and a mobile station (also referred to as “MS” above), that is, ranking information of a mobile station that each transceiver will service. At this time, the connection information between the plurality of transceivers 250 and the plurality of mobile stations 11 to 16, which is stored in the connection information table 210, may be based on Table 1.

TABLE 1

| Classification | First ranking | Second ranking |
|---|---|---|
| First transceiver | MS₁, MS₃, MS₄ | |
| Second transceiver | | MS₁, MS₂, MS₃, MS₄ |
| Third transceiver | MS₂ | MS₅, MS₆ |
| Fourth transceiver | MS₅, MS₆ | |

The controller 230 configures the frame depending on a time resource and a frequency resource allocated to the base station system 200, manages the connection information of the connection information table 210 by using a transceiver identification symbol, and provides a location-based communication access service to the plurality of mobile stations 11 to 16 by using the connection information of the connection information table 210.

Each of the plurality of transceivers 250 forms an independent communication area and communicates with a mobile station located at the corresponding communication area. Herein, a plurality of communication areas formed by the plurality of transceivers 250 may correspond to the plurality of subareas described in FIG. 1.

The first transceiver 251 forms a first communication area 251a and may communicate with the first mobile station (MS₁) 11, the third mobile station (MS₃) 13, and the fourth mobile station (MS₄) 14 that are located at the first communication area 251a.

The second transceiver 252 forms a second communication area 252a.

The third transceiver 253 forms a third communication area 253a and may communicate with the second mobile station (MS₂) 12 that is located at the third communication area 253a.

The fourth transceiver 254 forms a fourth communication area 254a and may communicate with the fifth mobile station (MS₆) 15 and the sixth mobile station (MS₆) 16 that are located at the fourth communication area 254a.

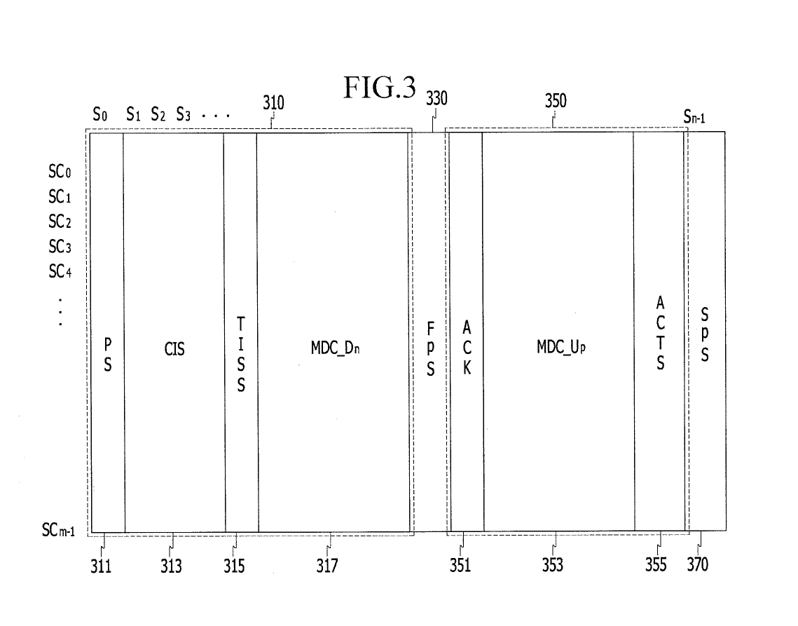

Next, referring to FIG. 3, a structure of a frame following an orthogonal frequency division multiple access (hereinafter referred to as “OFDMA”) method for providing a location-based communication service according to an embodiment of the present invention will be described.

FIG. 3 is a diagram illustrating a structure of an OFDMA frame according to an embodiment of the present invention.

As shown in FIG. 3, an OFDMA frame is constituted by a plurality of orthogonal frequency division multiplexing symbols (hereinafter referred to as “OFDM symbols”) determined depending on a plurality of time symbols S₀, S₁, S₂, S₃, . . . , Sₙ₋₁ and a plurality of subcarriers SC_{O} SC₁, SC₂, SC₃, SC₄, . . . , SCₘ₋₁, and includes a downlink frame section 310, a first protection section 330, an uplink frame section 350, and a second protection section 370. Herein, protection sections may be also called as “guide interval” The downlink frame section 310 is a section where a signal is transmitted from the base station system 200 to the mobile station, and includes a preamble section (referred to as “PS” in FIG. 3) 311, a control information section (referred to as “CIS” in FIG. 3) 313, a transceiver identification symbol section (referred to as “TISS” in FIG. 3) 315, and a message data channel-downlink (referred to as “MDC-Dn” in FIG. 3) 317.

The preamble section 311 indicates the start of the OFDMA frame.

The control information section 313 includes system control information (common control), basic information on a service provided by the base station system 200, and acknowledge information on a message data channel-uplink (hereinafter referred to as “MDC-Up”) of the previous OFDMA frame.

The transceiver identification symbol section 315 includes a transceiver indentifying symbol for the mobile station to measure the quality of the signal transmitted from each of the transceivers.

The message data channel-downlink 317 includes broadcast-type information that all the mobile stations can receive, and individual information data transmitted to the individual mobile stations.

The first protection section (referred to as “FPS” in FIG. 3) 330 partitions a downlink frame section 310 and an uplink frame section 350.

The uplink frame section 350 is a section where a signal is transmitted from the mobile station to the base station system 200, and includes acknowledge information section (referred to as “ACK” in FIG. 3) 351, a message data channel-uplink (MDC-Up) 353, and random association channels (referred to as “ACTS” in FIG. 3) 355.

The acknowledge information section 351 includes acknowledge information on the individual information data of the downlink data channel 317. The message data channel-uplink (MDC-Up) 353 includes the uplink individual information data transmitted to the base station system 200. The random association channel 355 includes random access request information used to request, maintain, or change link access. The second protection section (referred to as “SPS” in FIG. 3) 370 notifies that the OFDMA frame is terminated.

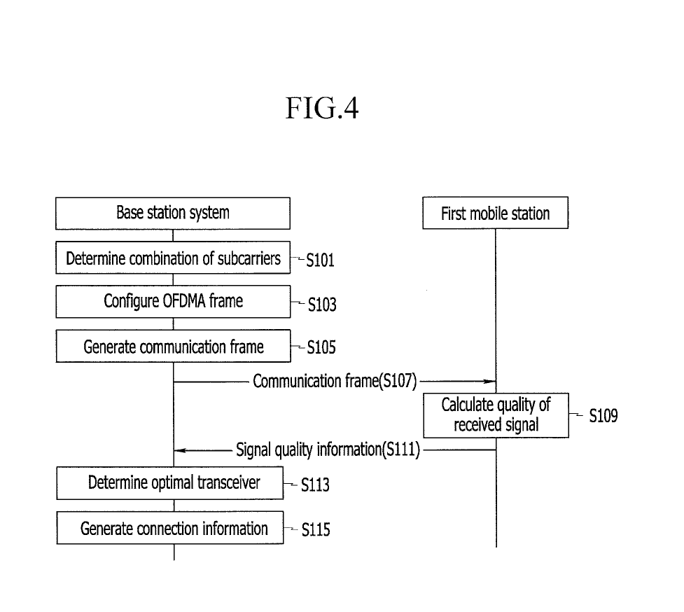

Next, referring to FIG. 4, a method for a base station system to generate connection information between a transceiver and a mobile station in order to allocate a channel to the mobile station will be described.

FIG. 4 is a diagram illustrating a method for generating connection information according to an embodiment of the present invention.

As shown in FIG. 4, first, a controller 230 of a base station system 200 allocates a plurality of subcarriers to a plurality of transceivers 250 by determining the subcarriers for the plurality of transceivers 250 on the basis of the frequency resource allocated to the base station system 200, that is, the plurality of subcarriers (S101).

Next, the controller 230 of the base station system 200 configures an OFDMA frame inserted with a transceiver identification symbol based on OFDMA (S103).

At this time, the OFDMA frame is constituted by a plurality of OFDM symbols, and includes a downlink frame section where a signal is transmitted from the base station system 200 to the mobile station and an uplink frame section where the signal is transmitted from the mobile station to the base station system 200. The downlink frame section includes a transceiver identification symbol section including a plurality of transceiver identification symbols. Further, the transceiver identification symbol section may correspond to the preamble section.

Thereafter, the controller 230 of the base station system 200 generates a plurality of communication frames corresponding to the plurality of transceivers 250, respectively, on the basis of the combination of the subcarriers for the plurality of transceivers 250 (S105).

At this time, the controller 230 may generate a first communication frame including a symbol corresponding to a subcarrier allocated to a first transceiver 251 among the plurality of transceiver identification symbols, may generate a second communication frame including a symbol corresponding to a subcarrier allocated to a second transceiver 252 among the plurality of transceiver identification symbols, may generate a third communication frame including a symbol corresponding to a subcarrier allocated to a third transceiver 253 among the plurality of transceiver identification symbols, and may generate a fourth communication frame including a symbol corresponding to a subcarrier allocated to a fourth transceiver 254 among the plurality of transceiver identification symbols.

Next, the base station system 200 transmits the plurality of communication frames to a first mobile station 11 through the plurality of transceivers 250 (S107).

At this time, the first transceiver 251 may transmit the first communication frame through the subcarrier allocated to the first transceiver 251, the second transceiver 252 may transmit the second communication frame through the subcarrier allocated to the second transceiver 252, the third transceiver 253 may transmit the third communication frame through the subcarrier allocated to the third transceiver 253, and the fourth transceiver 254 may transmit the fourth communication frame through the subcarrier allocated to the fourth transceiver 254.

Thereafter, the first mobile station 11 calculates the quality of a received signal between each transceiver and the first mobile station 11 on the basis of the plurality of received communication frames (S109).

At this time, the mobile station 11 may calculate the quality of a received signal between the first transceiver 251 and the first mobile station 11 on the basis of the transceiver identification symbol included in the first communication frame, may calculate the quality of a received signal between the second transceiver 252 and the first mobile station 11 on the basis of the transceiver identification symbol included the second communication frame, may calculate the quality of a received signal between the third transceiver 253 and the first mobile station 11 on the basis of the transceiver identification symbol included in the third communication frame, and may calculate the quality of a received signal between the fourth transceiver 254 and the first mobile station 11 on the basis of the transceiver identification symbol included in the fourth communication frame.

Further, the quality of the received signal between each transceiver and the first mobile station 11 may correspond to a value of a received signal strength indication (hereinafter referred to as “RSSI”). Further, the first mobile station 11 may calculate the quality of the received signal between each transceiver and the first mobile station 11 in accordance with Equation 1.

$${Q}_{t} = {\sum }_{k ∈ {K}_{t}} {\vert {r}_{k} \vert}^{2} \qquad ( Equation 1 )$$

At this time, factors of Equation 1 follow Table 2.

TABLE 2

| | |
|---|---|
| m | Number of subcarriers configuring a transceiver |
| | identification symbol |
| N | Number of transceivers controlled by a base station |
| I = {0, 1, . . . , m-1} | Set of subcarrier indexes configuring the transceiver |
| | identification symbol |
| T = {0, 1, . . . , N-1} | Set of indexes of transceivers controlled by the |
| | base station |
| Kₜ | Combination of subcarriers allocated to a |
| | transceiver t for identification the transceiver |
| rᵢ | Level of a received signal of an i-th subcarrier after |
| | fast Fourier transformation by receiving the |
| | received transceiver identification symbol, i ε I |
| Qₜ | Received signal quality of the transceiver t |

Next, the first mobile station 11 transmits signal quality information on the first mobile station 11, which includes the quality of the received signal between each transceiver and the first mobile station 11, to the base station system 200 (S111). At this time, the first mobile station 11 may transmit the signal quality information through the random association channel.

Thereafter, the controller 230 of the base station system 200 determines an optimal transceiver for the first mobile station 11 on the basis of the received signal quality information (S113). At this time, the controller 230 may determine a transceiver having the best signal quality for the mobile station 11, that is, the optimal transceiver, in accordance with Equation 2 on the basis of the received signal quality included in the signal quality information.

$$j = arg {max}_{i ∈ I} {Q}_{i} \qquad ( Equation 2 )$$

In Equation 2, represents the index of the optimal transceiver.

Next, the controller 230 of the base station system 200 generates connection information between the transceiver and the mobile station on the basis of the determined optimal transceiver for the first mobile station 11 (S115). At this time, the controller 230 may store the connection information between the transceiver and the mobile station in a connection information table 210.

As above, the base station system 200 receives the signal quality information from a plurality of mobile stations, and determines an optimal transceiver for each of the plurality of mobile stations to complete the connection information between the transceiver and the mobile station. Further, when the base station system 200 allocates a channel to a predetermined mobile station in accordance with the completed connection information, the base station system 200 may allocate the channel to the mobile station so that the corresponding mobile station performs communication through the optimal transceiver.

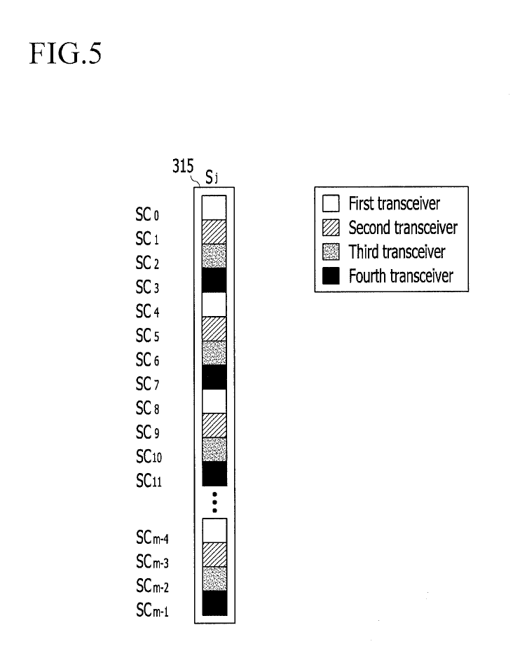

Next, referring to FIG. 5, a configuration of a transceiver identification symbol by a combination of subcarriers according to an exemplary embodiment of the present invention will be described.

FIG. 5 is a diagram illustrating one example of a configuration of a transceiver identification symbol according to an embodiment of the present invention.

As shown in FIG. 5, the transceiver identification symbol section 315 is allocated as one time symbol section Sⱼ.

When subcarriers allocated to the first transceiver 251 are SC_{O}, SC₄, SC₈, and SCₘ₋₄, a transceiver identification symbol that the first transceiver 251 will transmit is shown in FIG. 4.

When subcarriers allocated to the second transceiver 252 are SC₁, SC₅, SC₉, and SCₘ₋₃, a transceiver identification symbol that the second transceiver 252 will transmit is shown in FIG. 4.

When subcarriers allocated to the third transceiver 253 are SC₂, SC₆, SC₁₀, and SCₘ₋₂, a transceiver identification symbol that the third transceiver 253 will transmit is shown in FIG. 4.

When subcarriers allocated to the fourth transceiver 254 are SC₃, SC₇, SC₁₁, and SCₘ₋₁, a transceiver identification symbol that the fourth transceiver 254 will transmit is shown in FIG. 4.

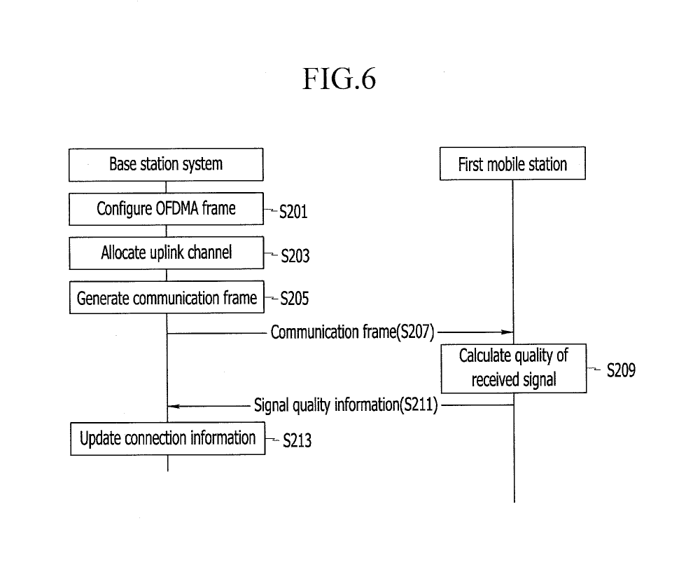

Next, referring to FIG. 6, a method for a base station system to update connection information between a transceiver and a mobile station in order to allocate a channel to the mobile station will be described.

FIG. 6 is a diagram illustrating a method for updating connection information according to an embodiment of the present invention.

As shown in FIG. 6, first, the controller 230 of the base station system 200 configures an OFDMA frame inserted with a transceiver identification symbol (S201).

At this time, the OFDMA frame is constituted by a plurality of OFDM symbols, and includes a downlink frame section where a signal is transmitted from the base station system 200 to the mobile station and an uplink frame section where the signal is transmitted from the mobile station to the base station system 200. The downlink frame section includes a transceiver identification symbol section including a plurality of transceiver identification symbols.

Next, the controller 230 of the base station system 200 allocates an uplink channel to the first mobile station 11 in accordance with the connection information between the transceiver and the mobile station, which is stored in the connection information table 210 (S203). At this time, the controller 230 may allocate the uplink channel for the first mobile station 11 so that the first mobile station 11 communicates with the optimal transceiver for the first mobile station 11 in accordance with the connection information between the transceiver and the mobile station.

Thereafter, the controller 230 of the base station system 200 generates a plurality of communication frames corresponding to the plurality of transceivers 250, respectively, on the basis of the predetermined combination of the subcarriers for the transceivers (S205).

At this time, the controller 230 may generate a first communication frame including a symbol corresponding to a subcarrier allocated to a first transceiver 251 among the plurality of transceiver identification symbols, may generate a second communication frame including a symbol corresponding to a subcarrier allocated to a second transceiver 252 among the plurality of transceiver identification symbols, may generate a third communication frame including a symbol corresponding to a subcarrier allocated to a third transceiver 253 among the plurality of transceiver identification symbols, and may generate a fourth communication frame including a symbol corresponding to a subcarrier allocated to a fourth transceiver 254 among the plurality of transceiver identification symbols.

Next, the base station system 200 transmits the plurality of communication frames to the first mobile station 11 through the plurality of transceivers 250 (S207).

At this time, the first transceiver 251 may transmit the first communication frame through the subcarrier allocated to the first transceiver 251, the second transceiver 252 may transmit the second communication frame through the subcarrier allocated to the second transceiver 252, the third transceiver 253 may transmit the third communication frame through the subcarrier allocated to the third transceiver 253, and the fourth transceiver 254 may transmit the fourth communication frame through the subcarrier allocated to the fourth transceiver 254.

Thereafter, the first mobile station 11 calculates quality of a received signal between each transceiver and the first mobile station 11 on the basis of the plurality of received communication frames (S209). At this time, the first mobile station 11 may calculate the quality of the received signal between each transceiver and the first mobile station 11 in accordance with Equation 1.

Next, if a transceiver having quality of the received signal that is better than the optimal transceiver of the first mobile station 11 is provided on the basis of the calculated quality of the received signal, the first mobile station 11 transmits the signal quality information on the first mobile station 11, which includes the quality of the received signal between each transceiver and the first mobile station 11, to the base station system 200 (S211). At this time, the first mobile station 11 may transmit the signal quality information to the base station system 200 through the allocated uplink channel.

Thereafter, the controller 230 of the base station system 200 changes the optimal transceiver for the first mobile station 11 on the basis of the received signal quality information on the first mobile station 11 (S213).

Next, the controller 230 of the base station system 200 updates the connection information between the transceiver and the mobile station on the basis of the changed optimal transceiver for the first mobile station 11. (S215). At this time, the controller 230 may update the connection information between the transceiver and the mobile station, which is stored in the connection information table 210, on the basis of the changed optimal transceiver of the first mobile station 11.

As such, when the optimal transceiver of the mobile station is changed, the base station system 200 can communicate with the optimal transceiver at the changed location by reflecting the changed matters to the connection information even though the location of the mobile station is changed through movement of the mobile station.

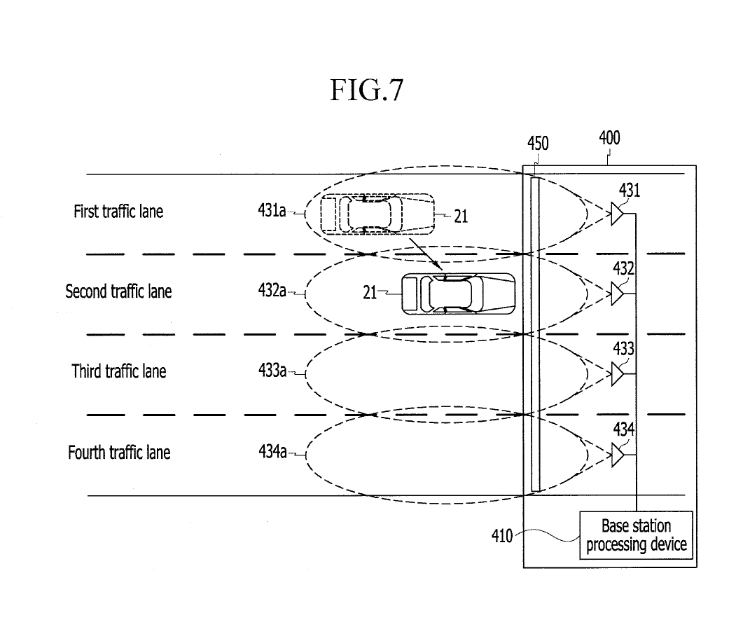

Next, referring to FIG. 7, an electronic toll collection (hereinafter also referred to as “ETC”) system according to an embodiment of the present invention will be described.

FIG. 7 is a diagram illustrating a configuration of an electronic toll collection system according to an embodiment of the present invention.

As shown in FIG. 7, the ETC system 400, as a system providing a service to allow a vehicle to arbitrarily change a traffic lane in a section where a toll is charged, includes a base station processing device 410, four transceivers, i.e., a first transceiver 431, a second transceiver 432, a third transceiver 433, a fourth transceiver 434, and a vehicle entry sensor 450.

The base station processing device 410 corresponds to a device for performing functions of the connection information table 210 and the controller 230 of the base station system 200 according to a first embodiment of the present invention, which is shown in FIG. 2.

The first transceiver 431 forms a first communication area 431a in a first traffic lane and operates in the first communication area 431a. At this time, the first transceiver 431 communicates with a mobile station positioned in the first communication area 431a through the first uplink channel determined by the combination of the subcarriers allocated to the first transceiver 431, that is, the combination of the first subcarriers.

The second transceiver 432 forms a second communication area 432a in a second traffic lane and operates in the second communication area 432a. At this time, the second transceiver 432 communicates with a mobile station positioned in the second communication area 432a through the second uplink channel determined by the combination of the subcarriers allocated to the second transceiver 432, that is, the combination of the second subcarriers.

The third transceiver 433 forms a third communication area 433a in a third traffic lane and operates in the third communication area 433a. At this time, the third transceiver 433 communicates with a mobile station positioned in the third communication area 433a through the third uplink channel determined by the combination of the subcarriers allocated to the third transceiver 433, that is, the combination of the third subcarriers.

The fourth transceiver 434 forms a fourth communication area 434a in a fourth traffic lane and operates in the fourth communication area 434a. At this time, the fourth transceiver 434 communicates with a mobile station positioned in the fourth communication area 434a through the fourth uplink channel determined by the combination of the subcarriers allocated to the fourth transceiver 434, that is, the combination of the fourth subcarriers.

The vehicle entry sensor 450 separates a violation vehicle from logical terminal existence information by communication in a corresponding area by collecting a vehicle number plate image through a camera at the time of vehicle's entering for identification a charging violation vehicle.

When a vehicle 21 corresponding to the mobile station is positioned at the first communication area 431a, the vehicle 21 communicates with the first transceiver 431 through the first uplink channel.

When the vehicle 21 moves from the first communication area 431a to the second communication area 432a, the vehicle 21 communicates with the second transceiver 432 through the second uplink channel.

At this time, since the signal reception quality of the transceiver identification symbol corresponding to the combination of the second subcarriers is the best, the vehicle 21 transmits the reception quality information including the signal reception quality between each transceiver and the vehicle 21 to the second transceiver 432.

Thereafter, the base station processing device 410 recognizes that the vehicle 21 enters the second communication area 432a by the received reception quality information, and the vehicle 21 may perform the communication through the second transceiver 432.

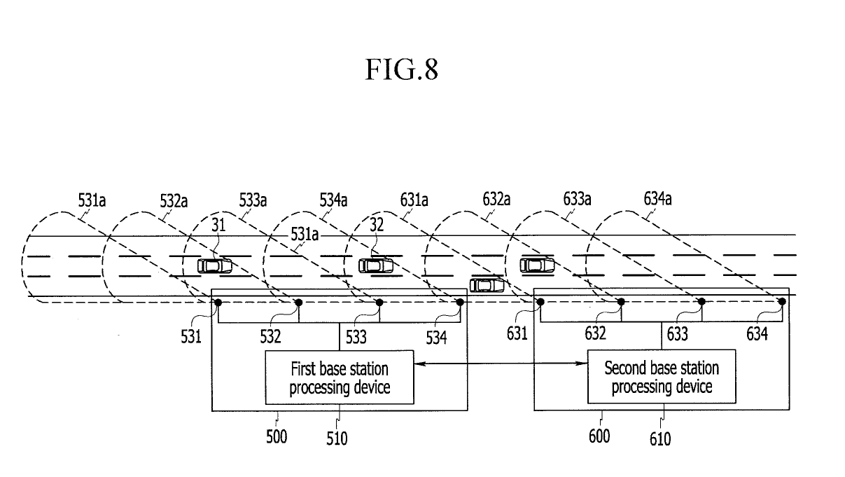

Next, referring to FIG. 8, a single frequency network (hereinafter also referred to as “SFN”) at the roadside using a base station system according to an embodiment of the present invention will be described.

FIG. 8 is a diagram illustrating a configuration of a single frequency network at the roadside according to an exemplary embodiment of the present invention.

As shown in FIG. 8, the single frequency network at the roadside includes a plurality of base station systems, i.e., a first base station system 500 and a second base station system 600.

The first base station system 500 includes a first base station processing device 510 and fourth transceivers, i.e., a first transceiver 531, a second transceiver 532, a third transceiver 533, and a fourth transceiver 534.

The second base station system 600 includes a second base station processing device 610 and four transceivers, i.e., a fifth transceiver 631, a sixth transceiver 632, a seventh transceiver 633, and an eighth transceiver 634.

The first base station processing device 510 and the second base station processing device 610 correspond to a device for performing the functions of the connection information table 210 and the controller 230 of the base station system 200 according to the first embodiment of the present invention, which is shown in FIG. 2.

The first transceiver 531 forms a first communication area 531a. The second transceiver 532 forms a second communication area 532a. The third transceiver 533 forms a third communication area 533a. The fourth transceiver 534 forms a fourth communication area 534a. The fifth transceiver 631 forms a fifth communication area 631a. The sixth transceiver 632 forms a sixth communication area 632a. The seventh transceiver 633 forms a seventh communication area 633a. The eighth transceiver 634 forms an eighth communication area 634a. The communication area of each transceiver partially overlaps with a communication area of an adjacent transceiver.

If a first vehicle 31 corresponding to the mobile station is positioned at a location where the second communication area 532a overlaps with the third communication area 533a, the first base station processing device 510 can know a moving situation of the first vehicle 31 in accordance with the signal quality information on the first vehicle 31 and the resource can be allocated to the first vehicle 31 through the third transceiver 533.

If a second vehicle 32 corresponding to the mobile station is positioned at a location where the fourth communication area 534a overlaps with the fifth communication area 631a, the first base station processing device 510 prevents a communication service that is in progress from being cut when the second vehicle 32 enters the fifth communication area 631a by sharing information on a service state of the second vehicle 32 with the second base station processing device 610. At this time, the fourth transceiver 534 and the fifth transceiver 631 can evade mutual interference by using different subcarriers.

According to an embodiment of the present invention, it is possible to provide different communication services depending on the location of a terminal or a mobile station that exists in a communication area of a base station with one frequency channel by using an orthogonal frequency division multiple access (OFDMA) method. Further, it is possible to provide a location-based communication service without an additional location recognition module.

The above-mentioned exemplary embodiments of the present invention are not embodied only by an apparatus and method. Alternatively, the above-mentioned exemplary embodiments may be embodied by a program performing functions that correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for communication channel control for a base station including a plurality of transceivers to provide a location-based service to a terminal, comprising:
designating an identification symbol section in a communication frame in order to identify the plurality of transceivers, and transmitting a predetermined transceiver identification signal through subcarriers granted to the plurality of transceivers by granting a combination of subcarriers to be used in the identification symbol section to each of the plurality of transceivers;
generating and storing terminal connection information for each of the plurality of transceivers by receiving information on evaluation of reception quality for the transceiver from the terminal and using the received information; and
allocating a communication resource so as to use the subcarrier of the transceiver connected with the terminal for communicating with the terminal.

2. The method of claim 1, wherein
the identification symbol section
corresponds to a preamble section of the communication frame.

3. A method for communication channel control for a terminal to receive a communication access service based on location of the terminal from a base station including a plurality of transceivers, comprising:
receiving a transceiver identification symbol signal included in a downlink frame section of a communication frame from the base station;
evaluating quality of a received signal of each of the plurality of transceivers by using a combination of subcarriers for each of the plurality of transceivers; and
transmitting transceiver identification result information including an evaluation result of the quality of the received signal to the base station.

4. The method of claim 3, wherein
the evaluating includes
calculating a received power value for the combination of the subcarriers for each of the plurality of transceivers.

5. The method of claim 4, wherein,
in the transmitting,
when a transceiver having a higher received power value than a main transceiver presently providing the service to the terminal is provided among the plurality of transceivers, the evaluation result is transmitted to the base station.

6. The method of claim 3, wherein,
in the transmitting,
the transceiver identification result information and the terminal information are transmitted to the base station through a predetermined random access channel in an uplink frame section of the communication frame.

7. The method of claim 3, wherein
the transmitting
includes transmitting the terminal information through a predetermined random access channel for each transceiver in the uplink frame section of the communication frame.

8. A method for communication channel control for a communication system including a plurality of base stations to provide a mobile access service using single frequency band, comprising:
allocating channels to the plurality of transceivers so that a plurality of transceivers included in a first base station among the plurality of base stations use different channels from adjacent transceivers taking charge of adjacent communication areas;
allowing the plurality of transceivers to transmit identification signals to the terminal by using subcarriers of the allocated channels by disposing a transceiver identification symbol section in a downlink frame depending on the channels allocated to the plurality of transceivers;
generating and storing terminal connection information for the plurality of transceivers on the basis of the transceiver identification result information received from the terminal; and
allocating a channel resource so as to transmit and receive signals through the transceiver connected to the terminal depending on the terminal connection information.

9. The method of claim 8, wherein
a second base station among the plurality of base stations has a communication area that overlaps with the first base station, and
the method for communication channel control
further includes, in a case where the terminal is recognized in a transceiver having a communication area that overlaps with the second base station among the plurality of transceivers depending on a movement direction of the terminal, transmitting a service situation together with the terminal from the first base station to the second base station so as to provide a continuous service when the terminal enters the communication area of the second base station.
